(19) United States
(12) Patent Application Publication
(10) Pub. No.: US 2008/0160135 A1
(43) Pub. Date: Jul. 3, 2008

(54) Method for Making a Tea Extract and a Tea Extract

(75) Inventor: Shi-Qiu Zhang, Tenafly, NJ (US)

Correspondence Address: UNILEVER PATENT GROUP, 800 SYLVAN AVENUE, AG West S. Wing, ENGLEWOOD CLIFFS, NJ, 07632-3100, US

(73) Assignee: Conopco, Inc., d/b/a Unilever, Englewood Cliffs, NJ (US)

(21) Appl. No.: 11/616,552

(22) Filed: Dec. 27, 2006

(51) Int. Cl. A23F 3/16; A23F 3/10; A23F 3/34

(52) U.S. Cl. 426/52; 426/435; 426/655; 426/597

(57) ABSTRACT

Shelf stable and ready-to-drink tea beverages are described. The tea beverages have excellent color and flavor characteristics and are prepared from a tea extract that has been made with both cold brew and standard tea leaf. The tea beverages maintain excellent characteristics in the absence of preservatives and caramel.

### FIELD OF THE INVENTION

The present invention is directed to a method for making a tea extract and a tea extract. More particularly, the present invention is directed to a method for making a tea extract from a mixture of cold and hot brew tea leaves. The resulting tea extract unexpectedly can be used to make a tea beverage that has excellent flavor, stability and color characteristics, and especially, when the tea extract is used to make a ready-to-drink tea beverage. Moreover, the excellent characteristics are surprisingly achieved when the tea beverage is substantitally free of preservative and artificial color, like caramel.

### BACKGROUND OF THE INVENTION

Excluding water, tea is the most popular beverage consumed by man. Tea is very refreshing, can be served either hot or cold, and has been made commercially available for many years. Lipton®, for example, is the world's leading brand of tea, made available in over 110 countries by Unilever.

Today, modern scientists are exploring the exciting potential of tea, which has a unique combination of natural antioxidants known as flavonoids that can include catechins, flavonols and flavonol glucosides. Taken regularly, tea can help improve vascular function, combat fatigue, reduce cholesterol levels and increase feelings of vitality

Antioxidants found in tea are believed to reduce the risk of cancer. In fact, studies indicate that antioxidants can lower the risks of cancer in the upper digestive tract, colon, rectum, pancreas and breasts.

Furthermore, and in our very hectic world, many consumers prefer teas that are ready-to-drink. Such teas, however, often require preservatives and/or artificial colorants (like caramel) that certain tea manufacturers require in order to deliver a product that appears to have stability and color attributes consistent with tea made by leaf infusion. Use of preservatives and artificial colorants, however, can discourage consumers from consuming tea since preservatives and artificial colorants are often associated with beverages that are not considered to be beneficial to one's health

It is of increasing interest to deliver a tea beverage (and especially a ready-to-drink tea beverage) that has flavor, stability and color attributes consistent with those found in tea made by leaf infusion while at the same time being free of preservatives and artificial colorants. This invention, therefore, is directed to a method for making a tea extract and a tea extract whereby the tea extract unexpectedly can be used to make a ready-to-drink tea beverage with flavor, stability and color attributes consistent with the attributes of tea made by leaf infusion, and surprisingly, substantially free of preservatives and artificial colors.

### Additional Information

Efforts have been disclosed for making tea beverages. In European patent No. 0 939 593 B1, tea beverages with high amounts of catechins are described

Other efforts have been disclosed for making tea beverages. In U.S. Pat. No. 6,780,454, cold water infusible tea leaf and beverages made from the same are described.

Still other efforts for making beverages have been disclosed. In U.S. Patent Application No. 2005/0123660 A1, tea beverages with improved flavor are described.

None of the additional information above describes a method for making a tea extract and a tea extract whereby the tea extract is prepared from a mixture of cold and hot brew tea leaves further whereby the tea extract can be used to make a tea beverage that unexpectedly has excellent flavor, stability and color characteristics while at the same time being substantially free of preservatives and artificial colors.

### SUMMARY OF THE INVENTION

In a first aspect, the present invention is directed to a method for making a tea extract comprising, in no particular order, the steps of:
(a) preparing a mixture of cold brew tea leaf with tea leaf, and extracting the mixture of tea leaf with water to produce tea percolate comprising tea solid, or
(b) extracting cold brew tea leaf to produce a cold brew percolate, and extracting tea leaf to produce leaf percolate and combining the cold brew percolate and leaf percolate to produce the tea percolate with tea solid, or
(c) both; and
(d) optionally, producing a tea extract by heating the leaf percolate, the cold brew percolate or both prior to combining, or by heating the tea percolate with tea solid,

the tea percolate with tea solid, the tea extract or mixture thereof, when diluted with water, is suitable to make a ready-to-drink tea beverage comprising 0.001 to about 6% by weight tea solid and that is shelf stable for at least about 25 weeks.

In a second aspect, the present invention is directed to the tea extract made via the method defined in the first aspect of this invention.

In a third aspect, the present invention is directed to a tea beverage made from the tea percolate with tea solids, tea extract or mixture thereof as defined in the second aspect of this invention.

Extracting, as used herein, means contacting leaf with water, and preferably, hot water in order to produce a percolate. Tea percolate with tea solids, as used herein, is meant to mean the liquid with tea solid product recovered after extracting tea leaf and cold brew tea leaf with water (preferably water with less about 200 ppm total dissolved solids with Mg, Zn and Al collectively less than 20 ppm, and preferably, less than 10 ppm in the water) where the total flavonoid level in the percolate is substantially the same as the flavonoid level in dry raw material tea leaf used to deliver tea leaf and cold brew tea leaf. Tea extract means the liquid and tea solid product resulting from the heating of the tea percolate with tea solids (about 0.5 to about 50% by weight tea solids based on total weight of the tea percolate with tea solids and including all ranges subsumed therein) where the tea extract comprises from about 0.5 to about 55% by weight tea solids based on total weight of the tea extract and including all ranges subsumed therein. Tea beverage as used herein is meant to include a beverage ready to consume such as a ready-to-drink tea beverage, and especially, a ready-to-drink black tea beverage. Substantially free of preservative and artificial colors means less than about 0.05% by weight (combined solids) based on total weight of the beverage composition, and preferably, from about 0.001 to about 0.04% by weight, and most preferably, no preservative and no artificial colors. Cold brew tea leaf means green tea leaf (i.e., Camellia sinesis) having been macerated and treated with tannase for a time long enough to allow the leaf to ferment and generate gallic acid and theaflavin wherein fermentation is continued in the presence of an oxygen containing substrate at an amount sufficient to activate endogeneous peroxidases further wherein the resulting fermented leaf is dried to yield cold brew tea leaf often having from about 2 to about 6 times higher levels of isotheaflavin, epitheaflavic acid and theaflagallin than tea leaf. Such a cold brew tea leaf is described in U.S. Pat. No. 6,780,454, the disclosure of which is incorporated herein by reference.

Tea leaf as used herein means tea leaf from Camellia sinesis that has not been treated with tannase and an oxygen containing substrate, and preferably, black tea leaf made commercially available by Unilever. Shelf stable as used herein means having an initial Hunter Haze Value of less than about 25, an initial darkness value (L) from about 15 to about 45, an initial redness value (a) from about 10 to about 40, and an initial yellow value (b) from about 8 to about 30 and final values that preferably are not more than 6, and most preferably, not more than 3 units off of the initial values after being stored at about ambient temperature for at least about 25 weeks while in light for about 12 hours each day, where all values can be obtained with a Hunter Lab DP 9000 Spectrophotometer and at ambient temperature.

### DETAILED DESCRIPTION OF THE PREFERRED EMBODIMENTS

There is no limitation with respect to how the tea percolate comprising tea solids is made as long as the same is the product of water being contacted with cold brew tea leaf and tea leaf. In a preferred embodiment, however, the tea percolate comprising tea solids is the result of an extraction process that extracts cold brew tea leaf and tea leaf that have been mixed together (including cold brew tea leaf and tea leaf extractions conducted with leaf in a tea bag). There is no limitation with respect to how the cold brew tea leaf and tea leaf are extracted, but column extraction is often preferred. Typically, the extraction is done at a temperature from about 20° C. to about 99° C., and preferably, from about 25° C. to about 95° C., and most preferably, from about 40° C. to about 60° C., including all ranges subsumed therein. The extraction may be done at any pressure as long as a tea percolate with tea solids may be produced. Typically, however, the pressure at which the extraction is conducted is about atmospheric and often the flow rate of water during the extraction process is from about 75 to 200 ml/min, and preferably, from about 80 to 175 ml/min, and most preferably, from about 110 to about 140 ml/min, including all ranges subsumed therein.

Regarding the amount of cold brew tea leaf and tea leaf used, typically a weight ratio from about 80:20 to about 20:80, and preferably, from about 70:30 to about 30:70, and most preferably, from about 40:60 to about 60:40 is used (cold brew tea leaf:tea leaf, respectively), including all weight ratios subsumed therein. The ratio selected can be used to make a mixture of tea leaf and cold brew tea leaf which is extracted to make the desired tea percolate with tea solids, or the cold brew tea leaf and tea leaf may be extracted separately after which the resulting cold brew percolate and leaf percolate (respectively) may be combined to produce the desired tea percolate with tea solids If the latter approach is desired, the ratio of cold brew percolate and leaf percolate, after mixing, should be consistent with what would have been tea percolate with tea solids made by extracting a mixture of cold brew tea leaf with tea leaf at the above identified leaf ratios. Often, the tea percolate with tea solids has from about 0.5 to about 50%, and preferably, from about 2.5 to about 25%, and most preferably, from about 3.0 to about 10% by weight tea solids, including all ranges subsumed. Such a tea, percolate with tea solids may be polished to remove molecules that have a molecular weight (Mw) greater than about 3,000, and such a polishing step is meant to include a standard centrifuge-based separation technique and filtering technique.

When making a tea beverage, the tea percolate with tea solids may be diluted with water. The water may be still or gas comprising (e.g., carbonated) and the tea beverage (i.e., ready-to-drink tea beverage) made will typically comprise from about 0.001 to about 6% by weight tea solids (including all ranges subsumed therein) and be shelf stable for at least about 25 weeks.

In a preferred but optional embodiment, a tea extract may be produced by heating the leaf percolate, the cold brew percolate or both prior to combining or by heating the tea percolate with tea solids. Thus, tea extract as used herein means a product comprising what is produced by heating percolate with tea solids, or a product produced by heating tea leaf percolate, cold brew percolate or both, prior to combining. In a more preferred optional embodiment, at least the leaf percolate is heated. In a most preferred optional embodiment, the tea-percolate with tea solids is heated to produce tea extract.

When making a preferred tea beverage, tea extract made by heating tea percolate with tea solids may be diluted with water. The water may be still or gas comprising and the tea beverage (i.e., ready-to-drink tea beverage) made will typically comprise from about 0.01 to about 6% by weight tea solids and be shelf stable for at least about 25 weeks, and preferably, at least about 35 weeks, and most preferably, at least about 39 weeks. The preferred ready-to-drink tea beverage preferably comprises from about 0.02 to about 3%, and most preferably, from about 0.1 to about 0.6% by weight tea solids, including all ranges subsumed therein. Moreover, the preferred ready-to-drink tea beverage is preferably made by diluting tea extract with cold water (e.g., about 20 to 28° C.) so that the tea beverage may preferably be hot filled or packed in a desired consumer friendly package and as described in U.S. Pat. No. 5,529,796, the disclosure of which is incorporated herein by reference.

When heating percolate like the tea percolate with tea solids, such a step is often done in a manner (which is free of oxidative conditions, for example, less than 2 ppm dissolved oxygen in the percolate) to induce Maillard reactions, glycosylamine production, glycosylamine rearrangements, amino acid and/or protein interactions with carbohydrates found in tea leaf, or a combination thereof.

Often, the heating is conducted at a temperature from about 65 to about 99° C., and preferably, from about 70 to about 98° C., and most preferably, from about 78 to about 97° C., including all ranges subsumed therein. The flow rate of percolate during heating is typically from about 1 to about 3 ml/minute, and preferably, from about 1.3 to about 2.6 ml/minute, and most preferably, from about 1.5 to about 2.2 ml/minute, including all ranges subsumed therein. In an especially preferred embodiment, the heating step takes place in an apparatus substantially free of oxygen, and most especially, free of conditions that will cause oxidation of tea components within the percolate being heated to make extract.

The ready-to-drink tea beverage made according to this invention will preferably have a Hunter Haze value less than about 20, and most preferably, less than about 15, a darkness value (L) from about 20 to about 40, and preferably from about 25 to about 35, and a redness value (a) from about 15 to about 38, and most preferably, from about 25 to about 35, and a yellow value (b) from about 15 to about 28, and most preferably, from about 20 to about 26, including all ranges subsumed therein and after about 35 weeks, and most preferably, after about 39 weeks.

It is within the scope of this invention to employ well known additives when making the ready-to-drink tea beverages of this invention. Such additives include chelator, sequestrant, flavor, vitamin, sweetener, fruit juices, herbal/botanical extracts, surfactant (like sorbitan monolaurate and sorbitan monoplamitate), acidulant (to achieve a pH between about 2.5 to 6.5), bitterness blockers, additional natural tea components (like catechins, caffeine) and the like. When employed, such optional additives, collectively, make up less than about 35% by weight of the total weight of the beverage.

The packaging which may be used for the ready-to-drink beverage product described herein is limited only to the extent that it is consumer safe and friendly. Often such packaging is a bottle (PCT or glass), can or tetrapak box.

The examples below are provided to facilitate an understanding of the invention and are not intended to limit the scope of the claims.

### EXAMPLE 1

A mixture of black tea leaf (Camellia sinesis) and cold brew tea leaf was made, weight ratio about 55:45, respectively. The resulting mixture was extracted with water at a flow rate of about 125 ml/min and at a temperature of about 50° C. to produce a tea percolate with tea solids. The same was subjected to a centrifugation step to remove molecules with a molecular weight (Mw) greater than about 3,000 (6000G for less than about 30 sec) and the resulting tea percolate with tea solids had a solids level of about 3.5% by weight.

The tea percolate with tea solids was heated (about 88° C.) under sealed conditions, in the absence of oxygen and at a flow rate of about 1.8 ml/minute. The resulting tea extract was diluted with water to produce the ready-to-drink tea beverages consistent with this invention (0.28% by weight tea solids and free of preservatives and artificial color).

### EXAMPLE 2

The method of Example 1 was repeated except that 100% black tea leaf was used in lieu of a mixture of black tea leaf and cold brew tea leaf and the resulting tea percolate with tea solids was not heated as described in Example 1. The ready-to-drink tea beverages made were similar to conventional ready-to-drink tea beverages made commercially available, and the beverages did contain artificial colors (about 0.002% by weight).

### EXAMPLE 3

Skilled panelists assessed the ready-to-drink teas made in the manner described in Examples 1 and 2 as well as commercially available ready-to-drink teas made with preservatives (e.g., sorbates) and artificial colors (e.g., caramel).

All panelists concluded that the ready-to-drink teas made according to Example 1 (free of preservatives and artificial colors) had better taste characteristics and the look of conventional ready-to-drink teas with preservatives and artificial colors. Moreover, the Haze, L, a and b values of the ready-to-drink beverages made according to Example 1 were consistent those of conventional ready-to-drink teas with preservatives and artificial colors and shelf stable for at least about 39 weeks.

The results indicate that the ready-to-drink tea beverages made according to this invention had better flavor, and stability and color attributes consistent with artificially colored ready-to-drink tea beverages.

What is claimed is:

1. A method for making a tea extract comprising, in no particular order,
(a) preparing a mixture of cold brew tea leaf with tea leaf, and extracting the mixture of tea leaf with water to produce tea percolate comprising tea solid, or
(b) extracting cold brew tea leaf to produce a cold brew percolate, and extracting tea leaf to produce leaf percolate and combining the cold brew percolate and leaf percolate to produce the tea percolate with tea solid, or
(c) both; and
(d) optionally, producing a tea extract by heating the leaf percolate, the cold brew percolate or both prior to combining, or by heating the tea percolate with tea solid,
the tea percolate with tea solid, the tea extract or mixture thereof, when diluted with water, is suitable to make a ready-to-drink tea beverage comprising 0.001 to about 6% by weight tea solid and that is shelf stable for at least about 25 weeks.

2. The method according to claim 1 wherein the tea percolate comprising tea solid is made according to step a and the tea percolate comprising tea solid is heated to produce the tea extract.

3. The method according to claim 1 wherein the tea extract comprises from about 0.5 to about 55% by weight tea solid.

4. The method according to claim 1 wherein the cold brew tea was prepared from tea leaf having been treated with tannase

5. The method according to claim 2 wherein the ready-to-drink tea beverage is shelf stable for about 35 weeks.

6. The method according to claim 2 wherein the ready-to-drink tea beverage is shelf stable for about 39 weeks.

7. The method according to claim 1 wherein the cold brew tea leaf and tea leaf are at a weight ratio from about 80:20 to about 20:80.

8. The method according to claim 1 wherein the cold brew tea leaf and tea leaf are at a weight ratio from about 70:30 to about 30:70.

9. The method according to claim 1 wherein the cold brew tea leaf and tea leaf are at a weight ratio from about 40:60 to about 60:40.

10. The method according to claim 2 wherein heating is conducted at a temperature from about 65 to about 99 degrees centigrade and at a flow rate from about 1 to about 3 ml/minute.

11. The method according to claim 10 wherein heating is conducted free of oxidative conditions.

12. A tea extract made according to the method of claim 1.

13. A ready-to-drink tea beverage made with the tea extract of claim 12.
